(19) United States
(12) Patent Application Publication
(10) Pub. No.: US 2015/0063756 A1
(43) Pub. Date: Mar. 5, 2015

(54) SYSTEM FOR TERMINATING ONE OR MORE OPTICAL FIBERS AND FIBER OPTIC CONNECTOR HOLDER USED IN SAME

(71) Applicant: Coring Cable Systems LLC, Hickory, NC (US)

(72) Inventors: Bradley Evan Hallett, Watauga, TX (US); Ashley Wesley Jones, Denton, TX (US); Daniel Leyva, JR., Arlington, TX (US); David Wayne Meek, Fort Worth, TX (US); Jackie Edwin Thomison, Fort Worth, TX (US)

(73) Assignee: Coring Cable Systems LLC, Hickory, NC (US)

(21) Appl. No.: 14/087,530

(22) Filed: Nov. 22, 2013

Related U.S. Application Data
(60) Provisional application No. 61/871,396, filed on Aug. 29, 2013.
(60) Provisional application No. 61/871,558, filed on Aug. 29, 2013.

(51) Int. Cl. G02B 6/36; G02B 6/24

(52) U.S. Cl. CPC G02B 6/3616; G02B 6/241
USPC 385/78; 385/137

(57) ABSTRACT

A system for terminating one or more optical fibers comprises a fiber optic connector, a connector holder, and an installation tool. The fiber optic connector has a ferrule and a connector housing in which the ferrule is at least partially positioned. The connector holder receives at least a portion of the connector housing and has a base portion that defines a bottom surface of the connector holder. The installation tool includes a body with a connector holding area configured to receive and cooperate with the base portion of the connector holder to securely position the fiber optic connector on the body.

### CROSS-REFERENCE TO RELATED APPLICATIONS

This application claims the benefit of priority under 35 U.S.C. §119 of U.S. Provisional Application Ser. Nos. 61/871,396 and 61/871,558, both of which were filed on Aug. 29, 2013, and both of whose content is relied upon and incorporated herein by reference in its entirety. This application also claims the benefit of priority under 35 U.S.C. §120 of U.S. patent application Ser. No. 14/070,876, filed on Nov. 4, 2013, the content of which is also relied upon and incorporated herein by reference in its entirety.

### BACKGROUND

The disclosure relates generally to optical fiber connectivity and more particularly to systems and methods for terminating one or more optical fibers.

Optical fibers are useful in a wide variety of applications, including the telecommunications industry for voice, video, and data transmission. Due at least in part to extremely wide bandwidth and low noise operation provided by optical fibers, the variety of applications in which optical fibers are being used is continuing to increase. For example, optical fibers no longer serve merely as a medium for long distance signal transmission, but are being increasingly routed directly to the home and, in some instances, directly to a desk or other work location.

In a system that uses optical fibers, there are typically many locations where one or more optical fibers are optically coupled to one or more other optical fibers. The optical coupling is often achieved by fusion splicing the optical fibers together or by terminating the optical fibers with fiber optic connectors. Fusion splicing has the advantage of providing low attenuation, but can make reconfiguring the system difficult, typically requires expensive tools to perform the operation, and involves additional hardware to protect the spliced area after the operation. Termination, on the other hand, provides the flexibility to reconfigure a system by allowing optical fibers to be quickly connected to and disconnected from other optical fibers or equipment.

One challenge associated with termination is making sure that the fiber optic connectors do not significantly attenuate, reflect, or otherwise alter the optical signals being transmitted. Performing termination in a factory setting (“factory termination”) is one way to address this challenge. The availability of advanced equipment and a controlled environment allow connectors to be installed on the end portions of optical fibers in an efficient and reliable manner. In many instances, however, factory termination is not possible or practical. For example, the lengths of fiber optic cable needed for a system may not be known before installation. Terminating the cables in the field (“field termination”) provides on-site flexibility both during initial installation and during any reconfiguring of the system, thereby optimizing cable management. Because field termination is more user-dependent, fiber optic connectors have been developed to facilitate the process and help control installation quality.

One example of such a development is the UNICAM® family of field-installable fiber optic connectors available from Corning Cable Systems LLC of Hickory, N.C. UNICAM® fiber optic connectors include a number of common features, including a mechanical splice between a preterminated fiber stub (“stub optical fiber”) and an optical fiber from the field (“field optical fiber”), and are available in several different styles of connectors, such as ST, SC, and LC fiber optic connectors. FIGS. 1A and 1B illustrate an exemplary fiber optic connector 10 belonging to the UNICAM® family of fiber optic connectors. A brief overview of the fiber optic connector 10 will be provided for background purposes. It should be noted, however, that the systems and methods disclosed herein are applicable to verifying the continuity of an optical coupling between any pair of interconnected optical fibers, and more particularly, between a field optical fiber and an optical fiber of any fiber optic connector, including single-fiber or multi-fiber connectors involving mechanical or fusion splices.

As shown in FIGS. 1A and 1B, the fiber optic connector 10 includes a ferrule 12 received in a ferrule holder 16, which in turn is received in a connector housing 19. The ferrule 12 defines a lengthwise, longitudinal bore for receiving a stub optical fiber 14. The stub optical fiber 14 may be sized such that one end extends outwardly beyond a rear end 13 of the ferrule 12. The fiber optic connector 10 also includes a pair of opposed splice components 17, 18 within the ferrule holder 16, a cam member 20 received over a portion of the ferrule holder 16 that includes the splice components 17, 18, a spring retainer 22 attached or otherwise held in place relative to the connector housing 19, and a spring 21 for biasing the ferrule holder 16 forwardly relative to the spring retainer 22 and connector housing 19. At least one of the splice components 17, 18 defines a lengthwise, longitudinal groove for receiving and aligning the end portion of the stub optical fiber 14 and an end portion of a field optical fiber 15 on which the fiber optic connector 10 is to be mounted. An index-matching material (e.g., index-matching gel) may be provided within this groove for reasons mentioned below.

To allow the fiber optic connector 10 to be mounted on the field optical fiber 15, the splice components 17, 18 are positioned proximate the rear end 13 of the ferrule 12 such that the end portion of the stub optical fiber 14 extending rearwardly from the ferrule 12 is disposed in the groove defined by the splice components 17, 18. The end portion of the field optical fiber 15 can be inserted through a lead-in tube (not shown in FIGS. 1A and 1B) and into the groove defined by the splice components 17, 18. By advancing the field optical fiber 15 into the groove defined by the splice components 17, 18, the end portions of the stub optical fiber 14 and the field optical fiber 15 make physical contact and establish an optical connection or coupling between the field optical fiber 15 and the stub optical fiber 14. The index-matching material (e.g., index-matching gel) provided within the groove surrounds this optical connection to help reduce losses in optical signals that are transmitted between the filed optical fiber 15 and stub optical fiber 14.

The splice termination of the fiber optic connector 10 is completed as illustrated in FIG. 1B by actuating the cam member 20, which engages a keel portion of the lower splice component 18 to bias the splice components 17, 18 together and thereby secure the end portions of the stub optical fiber 14 and the field optical fiber 15 relative to the groove defined by the splice components 17, 18. This step is typically completed using a specially-designed installation tool (a known example is mentioned below). The cable assembly may then be completed, for example, by strain relieving a buffer 25 of the field optical fiber 15 to the fiber optic connector 10 in a known manner.

FIGS. 2-4 illustrate an installation tool 30 that is an example of those offered by Corning Cable Systems for mounting the UNICAM® family of fiber optic connectors upon the end portion of a field optical fiber. Similar to the description above for the fiber optic connector 10, a brief overview will be provided for background purposes with the understanding that the systems and methods disclosed later herein are applicable to other types of installation tools. Indeed, as will be apparent, the systems and methods disclosed later herein may be applicable to any installation tool for terminating one or more optical fibers with a fiber optic connector.

The installation tool 30 includes a body or housing 32 having an actuation assembly 33 and cradle or carrier 36. The cradle 36 is slidable along guide rails 38 inside the body 32 and normally biased toward the actuation assembly 33, as shown in FIG. 3. Prior to inserting a fiber optic connector into the installation tool 30, the cradle 36 is moved away from the actuation assembly 33 (i.e., to the right in the example of FIG. 3). This movement may be achieved by pressing a load button 40, which is operably coupled to the cradle 36 through mechanical linkages (not shown) within the body 32. With the load button 40 depressed (FIG. 4), a user may place a fiber optic connector 10 into the space between the actuation assembly 33 and cradle 36, and subsequently move a lead-in tube 26 of the fiber optic connector 10 axially through a camming member or wrench 34 of the actuation assembly 33 until the cam member 20 is seated in the camming member 34. At this point, the lead-in tube 26 extends beyond crimp arms 44 that are positioned next to the actuation assembly 33. Before inserting a field optical fiber 15 into the lead-in tube 26, the load button 40 is released so that the cradle 36 moves back toward the actuation assembly 33 until the front portion of the fiber optic connector 10 is seated in a U-shaped cutout 42 on the cradle 36. A visual fault locator (VFL) assembly 46, the purpose of which will be briefly described below, is also slid toward the fiber optic connector 10 before closing a lid or cover 48 of the installation tool 30 and completing the termination process.

The field optical fiber 15 is eventually inserted into the back of the lead-in tube 26 of the fiber optic connector 10 until it abuts the stub optical fiber 15 (FIGS. 1A and 1B) within the splice components 17, 18. A user then actuates the cam member 20, for example by pressing a cam button 50 operably coupled to the camming member 34 by mechanical linkages (not shown), to bias the splice components 17, 18 together and thereby secure the stub optical fiber 14 and field optical fiber 15 between the splice components 17, 18. At this point the VFL assembly 46 may be used to check the splice connection between the stub optical fiber 14 and field optical fiber 15. The VFL assembly 46 includes an adapter 54, a coupler 60, a jumper (not shown; hidden within the installation tool 30), and an optical power generator (also hidden from view) in the form of a Helium Neon (HeNe) laser diode. The adapter 54 is an interchangeable component so that the VFL assembly can be used with different types/styles of fiber optic connectors. For example, as shown in FIGS. 5A and 5B, one adapter 54A may be provided to interface with LC-style connectors, which have a 1.25 mm-diameter ferrule. Another adapter 54B may be provided to interface with ST and SC-style connectors, both of which have 2.5 mm-diameter ferrules. Corning Cable Systems LLC also offers an adapter configured to interface with MTP-style connectors in some versions of the company's UNICAM® installation tool.

The adapters 54A, 54B and other components of the VFL assembly 46 are not the focus of this disclosure. Thus, the Corning Cable Systems LLC system/method for verifying an acceptable splice termination, which is commonly referred to as the “Continuity Test System” (CTS), and the combined functionality of the gas laser and jumper, which are commonly referred to as a “Visual Fault Locator” (VFL), will not be further described herein. Reference can instead be made to U.S. Pat. No. 8,094,988, for example, to obtain a more complete understanding of how the installation tool 30 advantageously incorporates continuity testing. Once an acceptable splice termination is verified, the crimp arms 44 are actuated by rotating a crimp knob 52 to secure the lead-in tube 26 onto the field optical fiber 15.

Although the installation tool 30 greatly facilitates the process of mounting the fiber optic connector 10 on the end portion of the field optical fiber 15, there remains room for improvement. For example, an inexperienced user may not immediately appreciate how to properly orient the fiber optic connector 10 when loading the installation tool 30. Because the connector housing 19 may have the same general shape on both ends (e.g., square), the user may accidentally believe that the U-shaped cutout 42 of the cradle 36 accommodates the rear end of the fiber optic connector 10 rather than the front end. Even if a user does orient the fiber optic connector 10 correctly, he or she may have questions about how far to insert the lead-in tube 26 through the camming member 34 and crimp arms 44. Consulting user manuals typically clears up any misconceptions or confusion, but all users may not be this diligent.

Therefore, an installation tool that addresses these and other challenges would be desirable.

### SUMMARY

One embodiment of the disclosure relates to a system for terminating one or more optical fibers. The system comprises a fiber optic connector, a connector holder, and an installation tool. The fiber optic connector has a ferrule and a connector housing in which the ferrule is at least partially positioned. The connector holder receives at least a portion of the connector housing and has a base portion that defines a bottom surface of the connector holder. The installation tool includes a body, which in turn includes a connector holding area configured to receive and cooperate with the base portion of the connector holder to securely position the fiber optic connector on the body.

Additional embodiments of the disclosure relate to connector holders like the connector holder mentioned above, but not limited to use in systems for terminating one or more optical fibers. In other words, some embodiments relate to connector holders used in connection with tools or equipment that may not be installation tools. A stand-alone test system for checking the splice connection in a mechanical splice fiber optic connector is one example of such a tool. In some of the additional embodiments, a connector holder includes a base portion and a holding portion extending from the base portion. The base portion defines a bottom surface of the connector holder and is shaped so that the bottom surface has a rotationally asymmetrical profile. The holding portion extends from the base portion and defines a receptacle configured to receive the fiber optic connector.

Additional features and advantages will be set forth in the detailed description which follows, and in part will be readily apparent to those skilled in the art. Indeed, it is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments. Persons skilled in the technical field of fiber optic connectors will appreciate how features and attributes associated with embodiments shown in one of the drawings may be applied to embodiments shown in others of the drawings.

### BRIEF DESCRIPTION OF THE DRAWINGS

FIG. 1A is a lengthwise cross-sectional view of one example of a fiber optic connector being mounted on a field optical fiber by inserting the field optical fiber through a rear end of the fiber optic connector;

FIG. 1B is a lengthwise cross-sectional view similar to FIG. 1A, but showing the field optical fiber mechanically spliced to a stub optical fiber within the fiber optic connector by means of splice components that have been moved to an actuated position by a cam member;

FIG. 2 is a perspective of one example of an installation tool for terminating a field optical fiber with a fiber optic connector, such as the fiber optic connector of FIGS. 1A and 1B, wherein the installation tool is shown in a closed configuration;

FIG. 3 is a perspective view of the installation tool of FIG. 2 in an open configuration prior to use;

FIG. 4 is a perspective view of the installation tool of FIG. 2 in an open configuration, wherein a fiber optic connector is shown being loaded into the installation tool;

FIGS. 5A and 5B are perspective views of adapters used in the installation tool of FIG. 2;

FIG. 6 is a perspective view of one embodiment of a system for terminating one or more optical fibers;

FIG. 7 is a perspective view of an example of a fiber optic connector and connector holder that may be used in the system of FIG. 6 and other embodiments of such systems;

FIG. 8 is a perspective view of an example of a connector holder for an LC-type fiber optic connector;

FIG. 9 is a perspective view of an example of a connector holder for an ST-type fiber optic connector;

FIG. 10 is a perspective view of an example of a connector holder for an SC-type fiber optic connector;

FIG. 11 is a perspective view of another embodiment of an installation tool for terminating an optical fiber with a fiber optic connector, prior to the fiber optic connector being loaded into the installation tool;

FIG. 12 is a perspective view of the installation tool of FIG. 11 after an LC-type fiber optic connector has been loaded into the installation tool using the connector holder of FIG. 8;

FIG. 13 is a perspective view of the installation tool of FIG. 11 after moving an adapter to interface with the fiber optic connector, wherein the adapter is part of a system for checking a splice connection in the fiber optic connector; and

FIGS. 14A-14D are perspective views of a portion of an embodiment of a test system for checking the splice connection between a stub optical fiber and field optical fiber within a fiber optic connector.

### DETAILED DESCRIPTION

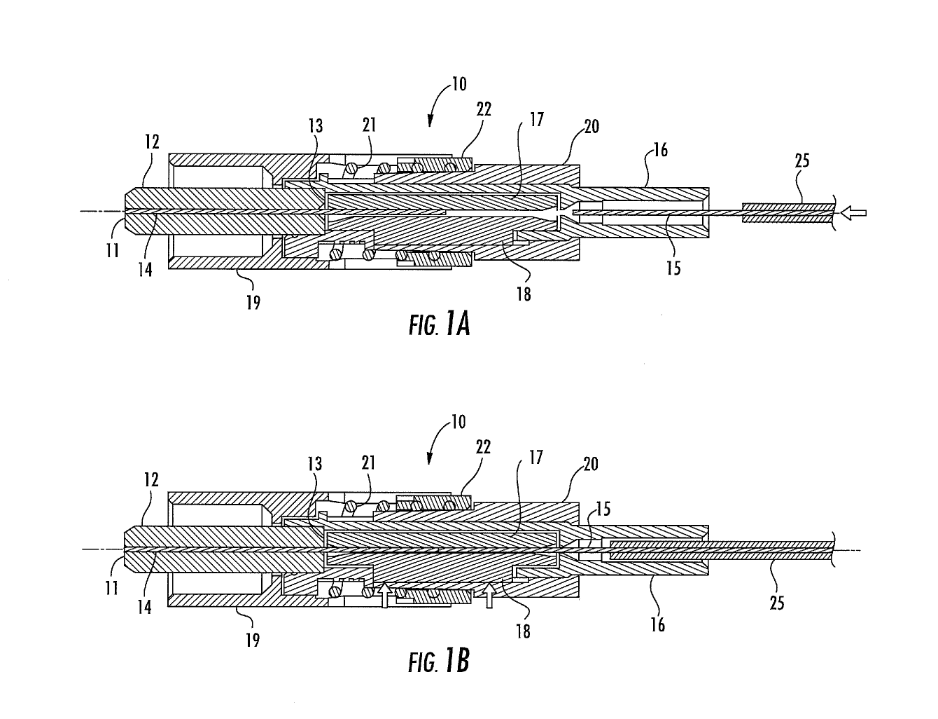

Various embodiments will be further clarified by the following examples, which relate to systems for terminating one or more optical fibers with a fiber optic connector and installation tools and connector holders used in such systems. The fiber optic connector may include one or more stub optical fibers to which one or more field optical fibers are optically coupled. To this end, the examples described below may be used in connection with the fiber optic connector 10 (FIGS. 1A and 1B). Reference can be made to the background section above for a complete description of the fiber optic connector 10, including how the cam member 20 is configured to the bias the splice components 17, 18 together to secure the field optical fiber 15 relative to the stub optical fiber 14 and thereby establish a mechanical splice connection. However, as noted in the background section, the examples disclosed herein may also be applicable to systems that involve other fiber optic connector designs. This includes systems for fiber optic connector designs that do not involve a mechanical splice connection. In such systems, the one or more optical fibers that are terminated may extend to a mating surface of the fiber optic connector or a lens formed on such a mating surface. Therefore, any references to the fiber optic connector 10 below are merely to facilitate discussion.

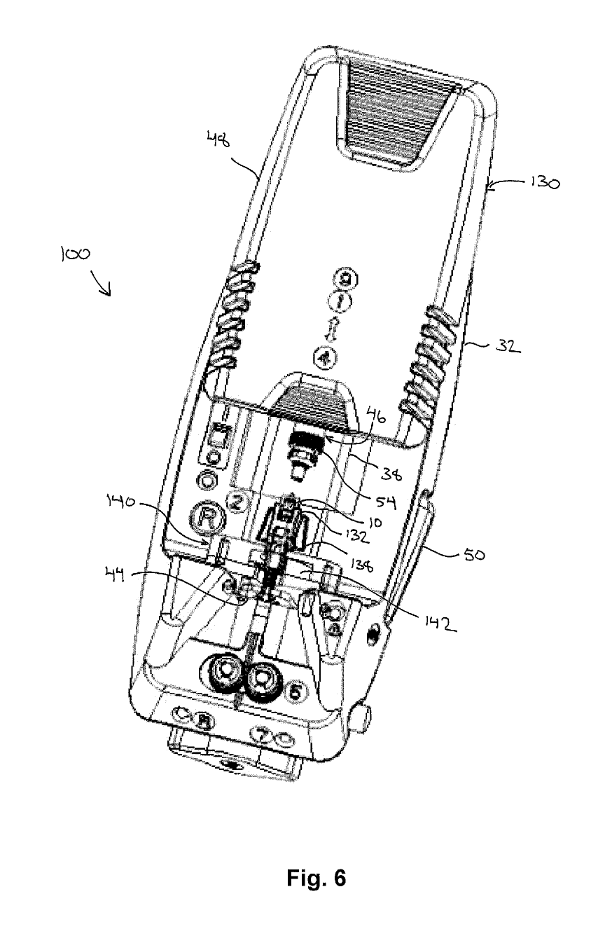

With this in mind, one embodiment of a system 100 for terminating one or more optical fibers will now be described with reference to FIG. 6. The system 100 includes an installation tool 130 similar the installation tool 30 such that the same reference numbers are used in the FIG. 6 to refer to elements corresponding to those discussed with respect to the installation tool 30. Only the differences between the installation tools 30 and 130 will be described below. The system 100 also includes the fiber optic connector 10 (again, which is merely an example of a fiber optic connector) and a connector holder 132 (alternatively referred to as a “handle” or “handler”) for supporting the fiber optic connector 10 on the body 32 of the installation tool 130. This aspect of the system 100 will be described below as well.

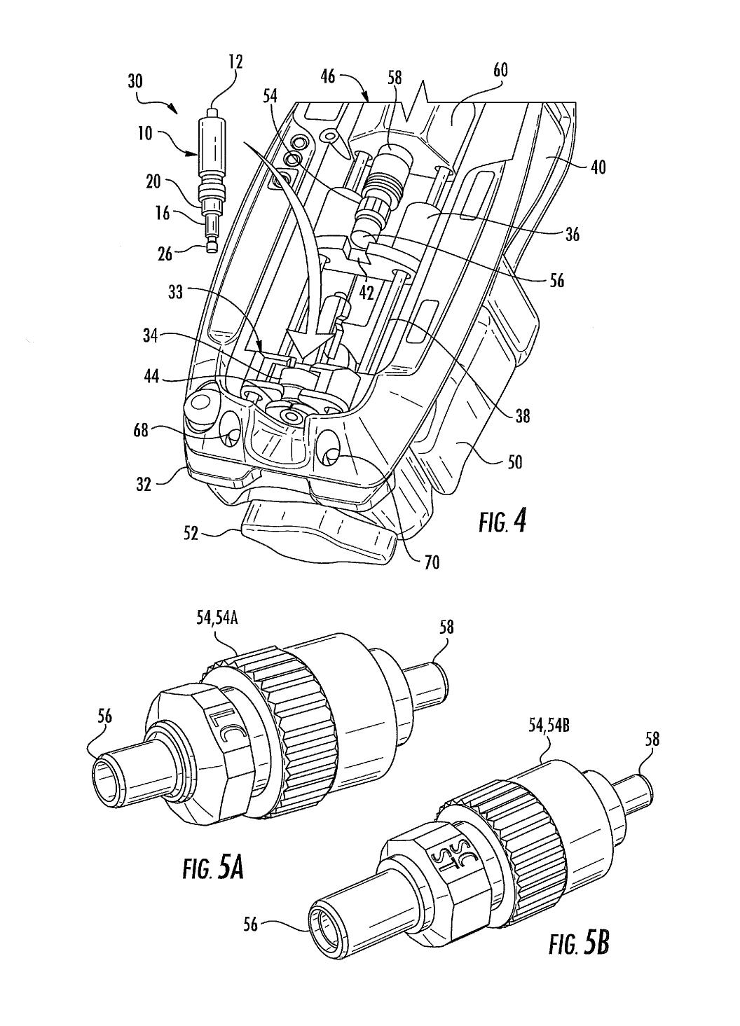

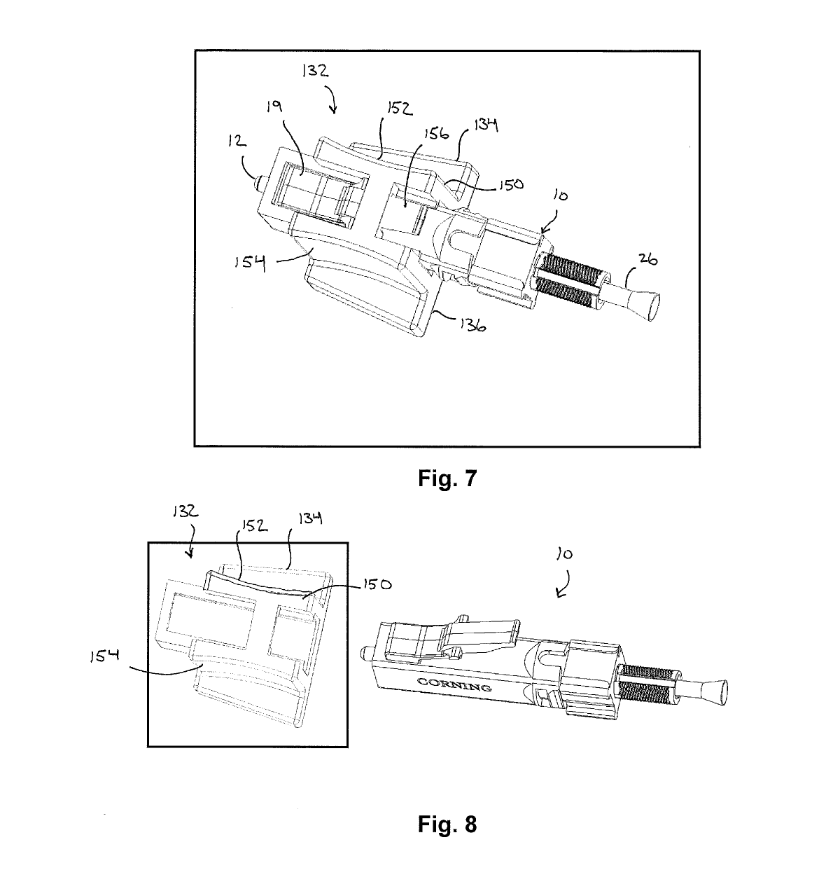

In general, the connector holder 132 receives at least a portion of the connector housing 19 (FIGS. 1A and 1B) so that the connector holder 132 can be mounted on the fiber optic connector 10. This step may be done by the manufacturer such that the connector holder 132 and the fiber optic connector 10 are pre-assembled for end users. Alternatively, the connector holder 132 and fiber optic connector 10 may be provided as separate components for an end user to assemble. The connector holder 132 includes a base portion 134 (FIG. 7) defining a bottom surface 136 of the connector holder 132. The body 32 of the installation tool 130 includes a carrier or other structure that defines a connector holding area 138 configured to received and cooperate with the base portion 134 of the connector holder 132 to securely position the fiber optic connector 10 on the body 32. The connector holding area 138 in the embodiment shown is in the form of a recess or receptacle having a shape corresponding to the shape of the base portion 134. An element like the cradle 36 (FIGS. 3 and 4) on the installation tool 30 is no longer necessary. In other words, the connector holding area 138 and connector holder 19 may be used instead of or in addition to the cradle 36 to securely position the fiber optic connector 10 relative to an actuation assembly 140 of the installation tool 130.

FIG. 6 illustrates the actuation assembly 140 being configured so that the fiber optic connector 10 can be loaded into the installation tool 130 prior to actuation and unloaded from the installation tool 130 after actuation along the same path of movement (e.g., in a vertical direction). The actuation assembly 140 effectively has an “always open” pathway perpendicular to a termination axis that is defined when the fiber optic connector 10 is loaded into the installation tool 130. The always open pathway is due to a camming member 142 having a unique configuration and moving in a particular manner relative to the body 32. These and other details relating to such an actuation assembly are fully described in U.S. Provisional Patent Application No. 61/871,558, entitled “FIBER OPTIC CONNECTOR INSTALLATION TOOL” and filed on Aug. 29, 2013, which is herein incorporated by reference in its entirety. Other configurations of the actuating assembly 140 will be appreciated by persons skilled in optical connectivity, including configurations like those in the UNICAM® installation tools previously or currently offered by Corning Cable Systems LLC (including the actuation assembly 33 discussed above for the installation tool 30).

FIG. 6 also illustrates various indicia provided on the body of the installation tool 130. In particular, numbers may be provided on the installation tool 130 proximate portions or components of the installation tool 130 that are associated with steps performed when using the installation tool 130 to terminate an optical fiber. The portions or components may be numbered sequentially, i.e., in the order in which they require action or attention when using the installation tool 130. By doing so, the installation tool 130 helps guide a user through the termination process to facilitate performing the right steps in the right order, thereby reducing or eliminating confusion and increasing the likelihood of proper operation (and, therefore, a successful termination). This “follow the numbers” feature may also make it easier for a user to recall the correct order of operations during subsequent uses of the installation tool 130. The connector receiving area 138 and connector holder 132 may be provided with numbers as part of the sequential numbering scheme. Alternatively or additionally, other indicia may be provided on the connector receiving area 138 and/or connector holder 132 for reasons mentioned below.

The connector holder 132 and fiber optic connector 10 are shown in isolation in FIG. 7. In the embodiment shown, the connector holder 132 includes a holding portion 150 extending from the base portion 134. The holding portion 150 defines a receptacle for receiving at least a portion of the connector housing 19. Although the holding portion 150 is shown as completely surrounding a portion of the connector housing 19, the holding portion 150 may alternatively define a U-shaped or otherwise open receptacle between first and second walls 152, 154 that define opposite sides of the holding portion 150. Any design that allows the connector holder 132 to be securely mounted onto the fiber optic connector 10 (or, stated differently, that allows the fiber optic connector 10 to be securely mounted onto the connector holder 132) will suffice. The secure mounting may be achieved by snap-fit between a portion of the connector holder 132 and a portion of the fiber optic connector 10 (e.g., a latch arm 156 extending from the connector housing 19), an interference fit, complementary locking elements engaging each other, or the like.

Advantageously, and as shown in FIG. 7, the holding portion 150 of the connector holder 132 may have a width less than a width of the base portion 134. Such an arrangement provides the connector holder 132 with a pedestal-like configuration that may be easier for a user to grip and manipulate when loading the connector holder 132 and fiber optic connector 10 into the installation tool 130. In particular, aligning the base portion 134 of the connector holder 132 with the connector receiving area 138 to allow the base portion 134 to be received therein may be facilitated by such a configuration. The first and second walls 152, 154 being curved inwardly toward each other may also improve ergonomics by making the connector holder 132 easier to grip (e.g., between a user's thumb and finger). However, in other embodiments the first and second walls 152, 154 may not be curved or may be provided with a different configuration than what is shown in FIG. 7.

Now referring to both FIGS. 6 and 7, it can be seen how in this embodiment the base portion 134 of the connector holder 132 and the connector holding area 138 of the installation tool 130 are shaped so that the connector holding area 138 only receives and cooperates with the base portion 134 when the connector holder 132 is in a desired orientation with respect to the installation tool 130. Stated differently, unless the connector holder 132 (and, therefore, the fiber optic connector 10 mounted to the connector holder 132) is oriented a desired way, the connector holding area 138 will not receive and cooperate with the base portion 134 to securely position the fiber optic connector 10. There is only one desired orientation in the embodiment shown; one where the rear end of the fiber optic connector 10 extends into the actuation assembly 140 and the front end faces the VFL assembly 46. Thus, unless the connector holder 132 is oriented in this particular way, the connector holding area 138 will not receive and cooperate with the base portion 134. Providing the base portion 134 with a shape that results in the bottom surface 136 of the connector holder 132 having a rotationally asymmetric profile, such as a trapezoid (as shown), and the connector holding area 138 with a complementary shape/profile, is one possible way of limiting the cooperation to a single orientation. The shapes and relationship, in effect, make the loading process for the fiber optic connector 10 more intuitive and increases the likelihood of proper positioning for the termination process. Additional advantages may be obtained by providing the connector holder 132 and connector holding area 138 with the same or similar coloring or indicia, thereby making the loading process even more intuitive.

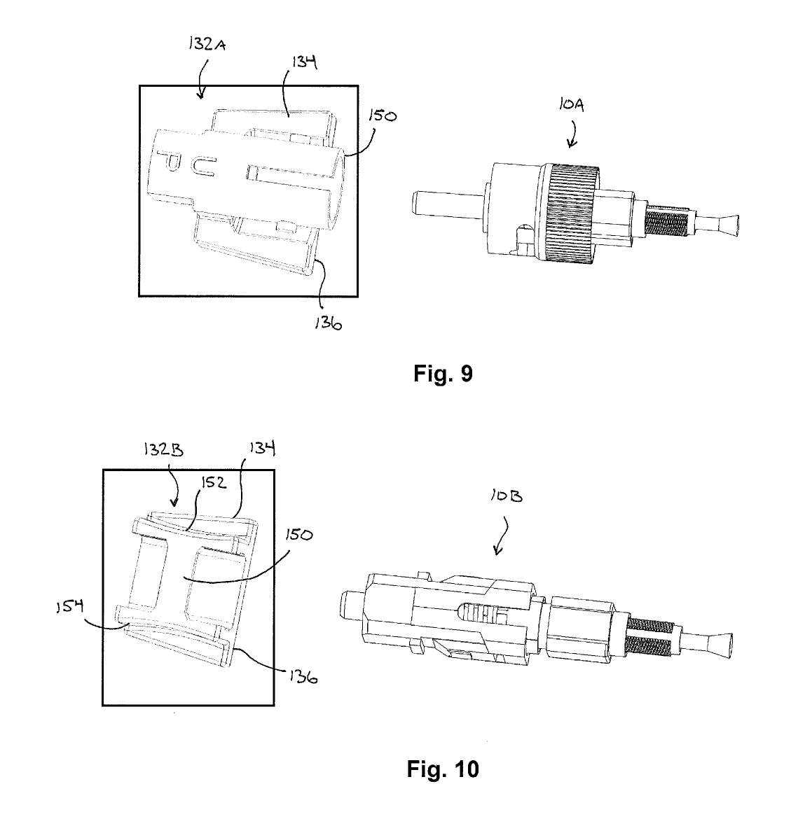

FIGS. 8-10 illustrate how different connector holder designs may be provided for different designs of fiber optic connectors. Connector holders 132, 132A, and 132B are shown for LC, ST, and SC-type fiber optic connectors 10, 10A, and 10B, respectively, as examples of this feature. In a manner not shown herein, connector holders may have designs for accommodating other types of fiber optic connectors. Advantageously, however, the base portion 134 of each connector holder design is similar. The similarity allows the different connector holder designs (and, therefore, different fiber optic connector designs) to be received in and cooperate with the same connector holding area 138 on the body 32 of the installation tool 130.

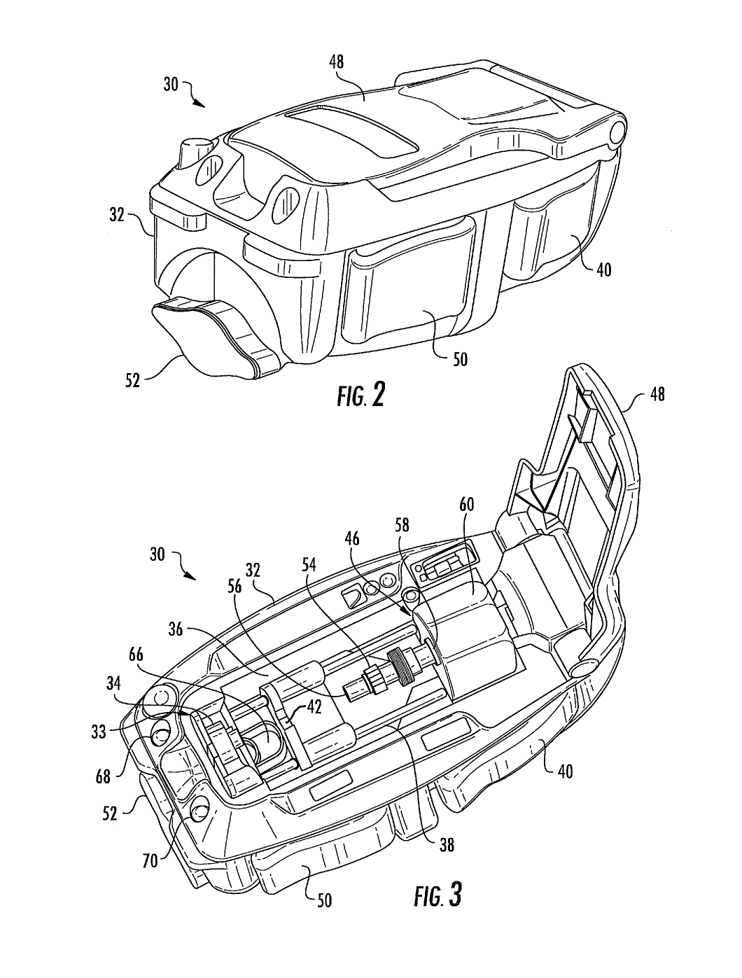

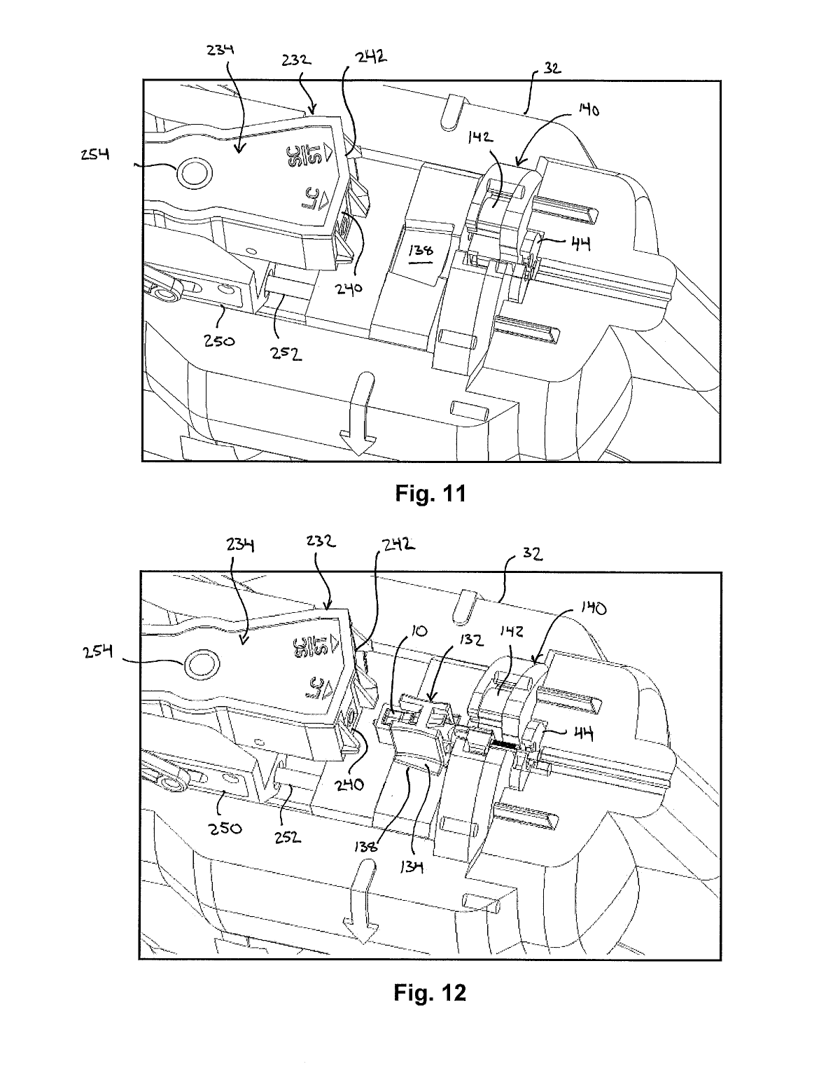

The general principles described above with respect to the connector holder 132 may be applicable to a wide variety of systems for terminating one or more optical fibers. For example, FIG. 11 illustrates a portion of an alternative embodiment of an installation tool 230 incorporating the features described above. The installation tool 230 is based upon the same or similar principles as the installation tools 30 (FIGS. 2-4) and 130 (FIG. 6), but has a different shape/configuration of components. Most notably, the installation tool 230 includes a movable adapter 232 to accommodate different fiber optic connector designs, as opposed to separate adapters 54 (FIGS. 3-5B). The adapter 232 is part of a test system 234 that serves the same purpose as the VFL assembly 46 in the installation tools 30 and 130, namely checking the splice connection that the installation tool 230 eventually establishes between a fiber optic connector and field optical fiber. A brief description of the test system 234 and how the connector holder 132 may be used to facilitate interfacing with the adapter 232 (in addition to positioning the fiber optic connector 10 relative to the actuating assembly 140) will be provided below. However, these and other aspects of the installation tool 230 are more fully described in U.S. Provisional Patent Application No. 61/871,396 (“the '396 application”), filed on Aug. 29, 2013, and U.S. patent application Ser. No. 14/070,876 (“the '876 application”), filed on Nov. 4, 2013, both of which are entitled “TEST SYSTEM FOR CHECKING A SPLICE CONNECTION BETWEEN A FIBER OPTIC CONNECTOR AND ONE OR MORE OPTICAL FIBERS”, and both of which are herein incorporated by reference in their entirety.

In general, the adapter 232 includes different connector receiving areas for interfacing with different designs of connector holders 132 and fiber optic connectors 10, such as those shown in FIGS. 8-10. First and second connector receiving areas 240, 242 are provided in the embodiment shown and at least partially defined by distinctly shaped connector receptacles on a front side of the adapter 232. The first connector receiving area 240 may be configured to interface with one or more designs of fiber optic connectors having a 1.25 mm diameter ferrule, such as LC-type fiber optic connectors, while the second fiber optic connector 242 may be configured to interface with one or more designs of fiber optic connectors having a 2.5 mm diameter ferrule, such as SC and ST-type fiber optic connectors. As described in the '396 and '876 applications, different embodiments may have different numbers of connector receiving areas to accommodate these same types/designs of connectors in a different manner (e.g., dedicated connector receiving areas for SC, ST, and LC-type fiber optic connectors) and/or to accommodate other types of fiber optic connectors.

Although not shown in FIG. 11, one or more optical power generators and one or more jumpers are provided as part of the test system 234, with the latter being coupled to a back end (not shown in FIG. 11) of the adapter 232 so that light energy can be delivered to the connector receiving areas 240. To this end, the optical power generator(s) and jumper(s) function in a manner similar to those part of the VFL assembly 46 (FIGS. 3 and 4). To allow the delivery of the light energy through the adapter 232, first and second jumpers (not shown) or other waveguides may extend from the back end of the adapter 232 to the first and second connector receiving areas 240, 242. Using the first and second jumpers is believed to help strip extraneous modes out of the light being launched into the fiber optic connector, particularly if the first and second jumpers are mandrel-wrapped within the adapter 232.

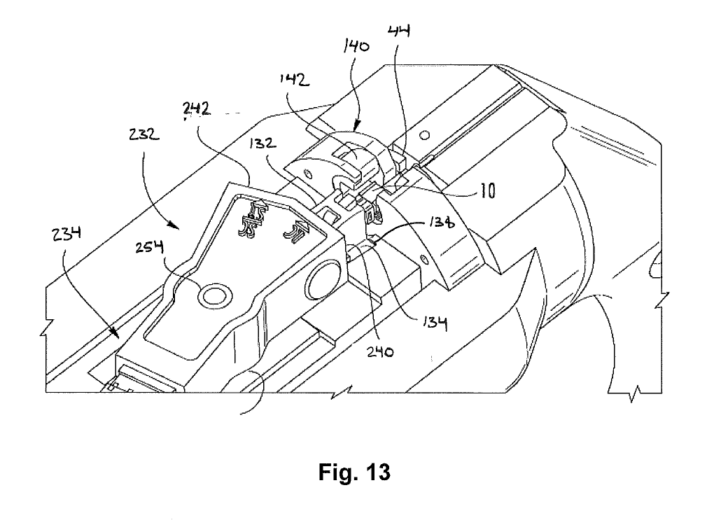

A general sequence of steps in using the installation tool 230 may involve first making sure that the adapter 232 is spaced from the connector holding area 138 (FIG. 11). This may be done by pressing a button (not shown) or other actuator operably coupled to a cradle 250 to which the adapter 232 is mounted in some embodiments, and in other embodiments by manually moving the adapter 232 and cradle 250 along guide rails 252 away from the connector holding area 138. The fiber optic connector 10 is then loaded into the installation tool 230 by positioning the connector holder 132 in the connector holding area 138, as shown in FIG. 12. Before or after this step, it may be necessary to rotate the adapter 232 about a pivotal connection 254 to align the appropriate connector receiving area 240, 242 with the fiber optic connector 10. The adapter 232 is then moved toward the fiber optic connector 10 to bring the first or second connector receiving area 240 (or 242, depending on the type of the fiber optic connector 10) into proximity of and/or engagement with the fiber optic connector 10. FIG. 13 illustrates the installation tool 230 after this step when an LC-type fiber optic connector 10 has been loaded into the installation tool 230. As can be appreciated, the cooperation between the base portion 134 of the connector holder 132 and the connector holding area 138 retains the fiber optic connector 10 in position. This helps ensure accurate and repeatable interfacing with the connector receiving areas 240, 242 on the adapter 232, thereby increasing the likelihood of the test system 234 operating as intended so that users can take benefit from the advantages associated with the test system 234 (namely the movable adapter 232 to accommodate different fiber optic connector designs/types).

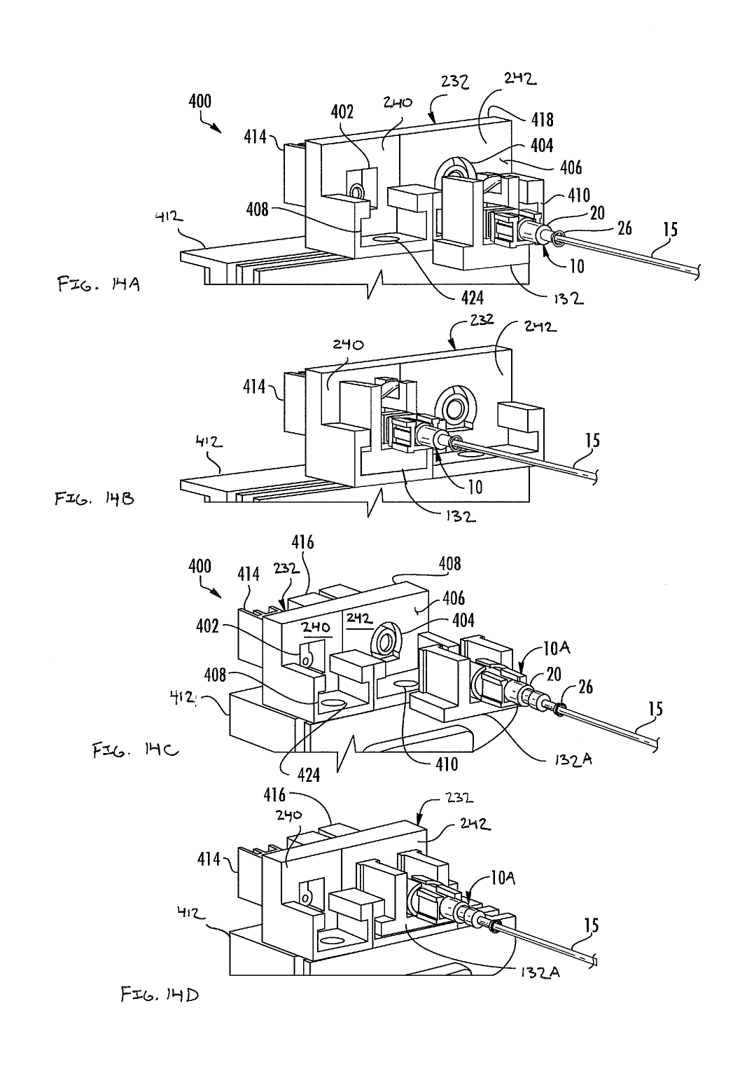

To this end, the connector holder 132 may be beneficial to use in connection other test systems that involve a movable adapter. The test systems may be integrated into an installation tool like the test system 234 such that the connector holder 132 securely positions a fiber optic connector relative to both an actuation assembly of the installation tool and the adapter of the test system. Alternatively, the test systems may be stand-alone systems. The adapter in such other integrated or non-integrated test systems may have a different form factor and may move in a different manner than the adapter 232. FIGS. 14A-14D illustrate a portion of a test system 400 as an example of these variations.

In the test system 400, the adapter 232 is shown as a block including first and second receptacles 402, 404 on a front side 406. The first and second receptacles 402, 404 have distinct shapes and at least partially define the first and second connector receiving areas 240, 242. The adapter 232 may also include first and second channels or guides 408, 410 extending from the front side 406 of the block to further define the first and second connector receiving areas 240, 242.

An optical power delivery system for the test system 400 is not shown in FIGS. 14A-14D to simplify matters. However, first and second mating structures 414, 416 can be seen on a rear side 418 of the adapter 232 opposite the first and second connector receiving areas 240, 242. The first and second mating structures 414, 416 are configured to receive and align the ends of jumpers that are coupled to one or more optical power generators (similar to the VFL assembly 46). Like the embodiment of FIGS. 11 and 12A-12C, the first connector receiving area 240 is configured to interface with LC-type fiber optic connectors. For example, the first receptacle 402 and/or first channel 408 may be shaped to only receive, engage, or otherwise mate with the connector holder 132 (FIGS. 6-8). The block of the adapter 232 may include a locking element 424 configured to cooperate with a complementary locking element (not shown) on the connector holder 132 to allow the components to be secured together. The locking element 424 may be in the form of a ball plunger, a spring plunger, latch, detent, magnet, or any other structure that is able to cooperate with the complementary locking element (e.g., a hole, pocket, flange, latch, magnet, etc.) to securely position the connector holder 132 relative to the adapter 232.

FIG. 14A illustrates the adapter 232 in a first position with the first connector receiving area 240 aligned with a fiber optic connector 10, which is a LC-type fiber optic connector, and FIG. 14B illustrates the fiber optic connector 10 and connector holder 132 moved to engage and interface with the first connector receiving area 240. When in this position, the ferrule 12 of the fiber optic connector 10 is aligned with and optically coupled to a jumper of the optical power delivery system. The splice connection between the stub optical fiber 14 and field optical fiber 15 within the fiber optic connector 10 may then be checked in a manner similar to that discussed above for the VFL assembly 46 of the installation tool 30.

In the embodiment shown, the second connector receiving area 242 is configured to interface with SC and ST-type fiber optic connectors. Thus, if the fiber optic connector whose splice connection is being tested is either an SC or SC-type fiber optic connector rather than a LC-type fiber optic connector, the adapter 232 is moved relative to a body 412 to a second position shown in FIG. 14C to align the second connector receiving area 242 with the fiber optic connector 10. The movement of the adapter 232 is translational (e.g., sliding movement) rather than rotational in this embodiment.

The manner in which the second connector receiving area 242 is configured to interface with the fiber optic connector 10 may be similar to that discussed above with respect to the first connector receiving area 240. That is, the second receptacle 404 and/or second channel 410 may be shaped to only receive, engage, or otherwise mate with a connector holder 132 associated with SC or ST-type fiber optic connectors. FIG. 14D illustrates the fiber optic connector 10 and connector holder 132A moved to engage and interface with the second connector receiving area 242. When in this position, the ferrule 12 of the fiber optic connector 10A is aligned with and optically coupled to a jumper of the optical power delivery system. The splice connection between the stub optical fiber 14 and field optical fiber 15 within the fiber optic connector 10A may then be checked in the manner described above.

Note that the first and second connector receiving areas 240, 242 may be labeled and/or color coded to match labels and/or colors of the connector holders 132. Such labeling and/or color coding makes it easier for a user to know whether to move the adapter 232 to the first or second position.

It will be apparent to those skilled in the art that further embodiments, modifications, and variations can be made without departing from the scope of the claims below. Since modifications, combinations, sub-combinations, and variations of the disclosed embodiments may occur to persons skilled in the art, the invention should be construed to include everything within the scope of the appended claims and their equivalents.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

1. A system for terminating one or more optical fibers, comprising:
a fiber optic connector having a ferrule and a connector housing in which the ferrule is at least partially positioned;
a connector holder that receives at least a portion of the connector housing, the connector holder having a base portion defining a bottom surface of the connector holder; and
an installation tool having a body configured to support the fiber optic connector, wherein the body of the installation tool includes a connector holding area configured to receive and cooperate with the base portion of the connector holder to securely position the fiber optic connector on the body.

2. A system according to claim 1, wherein the connector holding area on the installation tool comprises a recess having a shape corresponding to the base portion of the connector holder.

3. A system according to claim 1, wherein the base portion of the connector holder and connector holding area of the installation tool are shaped so that the connector holding area only receives and cooperates with the base portion when the connector holder is in a first orientation with respect to the installation tool.

4. A system according to claim 3, wherein the base portion of the connector holder is shaped so that the bottom surface of the connector holder has a rotationally asymmetrical profile.

5. A system according to claim 1, wherein the connector holder and connecting holding area comprise matching indicia, colors, or both indicia and colors.

6. A system according to claim 1, wherein the connector holder and connector holding area comprise complementary locking features configured to engage each other when the connector holder is received in the connector holding area.

7. A system according to claim 1, wherein the connector holder further includes a holding portion extending from the base portion and defining a receptacle for receiving at least a portion of the connector housing, wherein an end face of the ferrule remains accessible when the fiber optic connector is received in the receptacle.

8. A system according to claim 7, wherein the holding portion comprises first and second walls defining opposite sides of the holding portion, the first and second walls being curved inwardly toward each other.

9. A system according to claim 7, wherein the holding portion of the connector holder has a width less than a width of the base portion.

10. A system according to claim 1, wherein:
the fiber optic connector further comprises one or more stub optical fibers securely positioned within a bore of the ferrule;
the installation tool further comprises an actuation assembly configured to receive a portion of the fiber optic connector into which the one or more optical fibers may be inserted to be brought into contact with the one or more stub optical fibers, the actuation assembly also being configured to actuate the portion of the fiber optic connector received therein to establish a mechanical splice connection between the one or more optical fibers and the one or more stub optical fibers; and
the connector holder securely positions the fiber optic connector on the body of the installation tool in relation to the actuation assembly.

11. A system according to claim 10, wherein the installation tool further comprises a visual fault locator assembly (VFL) having an optical power delivery system configured to deliver light energy to the one or more stub optical fibers of the fiber optic connector when the connector holder is received by and cooperates with the connector holding area to securely position the fiber optic connector on the installation tool.

12. A system according to claim 10, wherein the fiber optic connector further comprises two or more splice components into which the one or more stub optical fibers extend from the bore of the ferrule and a cam member at least partially surrounding the two or more splice components, the cam member being the portion of the fiber optic connector configured to be received and actuated by the actuation assembly of the installation tool.

13. A system according to claim 12, wherein the actuation assembly comprises a camming member that is movable relative to the body of the installation tool so as to be configured to actuate the cam member of the fiber optic connector.

14. A system according to claim 1, further comprising a plurality of the fiber connectors and a plurality of the connector holders, wherein the plurality of fiber optic connectors comprises at least two different designs of fiber optic connectors, and further wherein the plurality of connector holders comprises at least two different designs of connector holders for receiving the at least two different designs of fiber optic connectors, the base portion of each connector holder being similar for the at least two different designs of connector holders.

15. A system according to claim 14, wherein the two different designs of fiber optic connectors comprises at least two of the following: SC, ST, and LC-type fiber optic connectors.

16. A system according to claim 1, wherein the body of the installation tool is configured to support the connector holder so that the fiber optic connector is aligned along a termination axis when the connector holder is positioned in the connector holding area, and further wherein the actuation assembly is configured so that the fiber optic connector can be loaded into the actuation assembly prior to actuation and unloaded from the actuation assembly after actuation along the a path of movement substantially perpendicular to the termination axis.

17. A connector holder for securely positioning a fiber optic connector on a body, the connector holder comprising:
a base portion defining a bottom surface of the connector holder; and
a holding portion extending from the base portion and defining a receptacle configured to receive the fiber optic connector;
wherein the base portion is shaped so that the bottom surface has a rotationally asymmetrical profile.

18. A connector holder according to claim 17, wherein the holding portion comprises first and second walls defining opposite sides of the holding portion, the first and second walls being curved inwardly toward each other.

19. A connector holder according to claim 17, wherein the holding portion of the connector holder has a width less than a width of the base portion.

20. A fiber optic assembly, comprising:
a fiber optic connector having a ferrule and a connector housing in which the ferrule is at least partially positioned; and
a connector holder having a base portion defining a bottom surface of the connector holder and a holding portion extending from the base portion, the base portion being shaped so that the bottom surface has a rotationally asymmetrical profile, and the holding portion defining a receptacle in which the connector housing of the fiber optic connector is at least partially received.
